(19) United States
(12) Patent Application Publication
(10) Pub. No.: US 2016/0052719 A1
(43) Pub. Date: Feb. 25, 2016

(54) FILL SYSTEM AND METHOD USING STORAGE CONTAINER WITH AGITATOR PLATE FOR ADHESIVE SOLIDS

(71) Applicant: Nordson Corporation, Westlake, OH (US)

(72) Inventors: Charles P. Ganzer, Cumming, GA (US); Enes Ramosevac, Snellville, GA (US)

(21) Appl. No.: 14/812,014

(22) Filed: Jul. 29, 2015

Related U.S. Application Data
(60) Provisional application No. 62/041,271, filed on Aug. 25, 2014.

(51) Int. Cl. B65G 19/04; B29C 31/04; B29B 13/02; G05D 9/12

(52) U.S. Cl. CPC B65G 19/04; G05D 9/12; B29C 31/04; B29B 13/022

(57) ABSTRACT

A fill system retains and transfers adhesive solids of different types and compositions to adhesive melter(s). The fill system includes a storage container for holding a bulk supply of adhesive solids and an agitator plate adjacent to the bottom end of the storage container. A vibration generating mechanism vibrates the agitator plate against the bottom surface of the bulk supply to separate a flow of fluidized adhesive solids from the bulk supply and then controllably deliver this flow to one or more pumps feeding the melter(s). When the agitator plate stops vibrating, the flow of fluidized adhesive solids stops moving out of the storage container. Thus, the fill system provides adhesive solids on demand to pumps and reduces clogging caused by coalesced masses of adhesive.

### CROSS REFERENCE TO RELATED APPLICATIONS

This application claims the priority of U.S. Provisional Patent Application Ser. No. 62/041,271, filed on Aug. 25, 2014 (pending), the entire disclosure of which is hereby incorporated by reference herein.

### TECHNICAL FIELD

The present invention relates generally to hot melt adhesive systems, and more particularly, to fill systems for temporarily storing and transferring unmelted hot melt adhesive solids to pumps that feed melters or dispenser devices.

### BACKGROUND

Hot melt adhesive systems have many applications in manufacturing and packaging. For example, thermoplastic hot melt adhesives are used for carton and case sealing, tray forming, pallet stabilization, nonwoven applications including diaper manufacturing, and many other applications. Hot melt adhesives are typically produced in the form of adhesive “solids,” which include solid or semi-solid pellets and/or particulates. These hot melt adhesive solids are transferred to a melter where the hot melt adhesive solids are melted into a molten liquid form at a desired application temperature. The liquid hot melt adhesive is ultimately dispensed at the application temperature to an object such as a work piece, substrate or product by a dispensing device suitable to the manufacturing or packaging application.

In these hot melt adhesive systems, a supply of unmelted hot melt adhesive solids must be retained and transferred to the melter in order for the melter to continually produce the liquid hot melt adhesive used by the dispensing device. For example, it is known for a person to employ a scoop or bucket to retrieve hot melt adhesive solids from a bulk supply, and to deliver those adhesive solids directly to the melter. This manual process may be undesirable because hot melt adhesive dust may be stirred up during handling and because transferring hot melt adhesive solids in this manner is prone to waste caused by spillage. In addition, manual filling of the melter substantially increases the amount of operator time that must be spent attending to the supply of adhesive solids to the melter.

To address these concerns with manual filling, the adhesive material may be provided on demand by automated filling, depending on the specific design of the melter. In some of these systems, the adhesive solids are designed to be transferred by pressurized air from a pneumatic pump of a fill system into the melter, whenever the melter requires additional adhesive material to heat and dispense. In this regard, the fill system ensures that the amount of adhesive material within the melter remains at sufficient levels during operation of the dispensing system. The fill system must be supplied reliably with additional adhesive solids in order to meet the demands of the melter and its associated dispensing device(s) during operation.

One particular type of known fill system is defined by a tote-based pneumatic fill system. The tote-based pneumatic fill system includes a supply container or “tote” with an interior space having a size sufficient to hold enough adhesive solids for multiple hours of operation of the melter(s) connected to the fill system. A transfer pump, such as a pneumatic pump, connects to the tote for moving the adhesive solids via a hose from a lower portion of the tote to the melter. Traditionally, the adhesive solids will gravity feed into the lower portion of the tote toward an inlet of the transfer pump, and this gravity feed leads to a submerging of the pump inlet with adhesive solids.

Pneumatic pumps generally rely on the suction of gas, such as air entrained within gaps between individual pieces of adhesive solids, for moving the adhesive solids at the pump inlet. When the pneumatic pump generates a vacuum at the inlet to draw some of the adhesive solids out of the tote, make-up or replacement gas is typically drawn through the entire height of adhesive solids stacked within the tote, and this can be difficult. As a result, the transfer pump in conventional tote-based fill systems may become starved for air, which hampers the ability to produce the vacuum required in order to continue moving adhesive solids from the tote.

The adhesive solids may also have a tendency to stick together and form large clumps of adhesive in some environments, further exacerbating the problems with reliably removing the adhesive solids from the tote with the transfer pump. To this end, the clumps of adhesive can become lodged in and block the pump inlet, and the clumps of adhesive also adversely affect the drawing of make-up or replacement gas though the stacked adhesive solids to the pump inlet. This problem with clumping or sticking together is particularly problematic when the adhesive material defines softer formulations, such as rubber-based formulations that tend to be more malleable and sticky under pressure, and also when the tote is used in a relatively warm operating environment. As many of the conventional totes are configured to hold over 150 pounds of adhesive solids for enabling multiple hours of operation, the pump inlets tend to become clogged or starved for air more readily when the tote is completely filled with adhesive (as the weight of adhesive applying pressure to adhesive solids near the pump inlet is greater when the tote is completely filled). However, it is not desirable to only partially fill the tote during each refill cycle because that causes the amount of operator time needed to replenish the supply of adhesive solids in the tote to increase to an undesirable level, perhaps even comparable to operator time for manual filling processes.

Current methods for avoiding clumping or sticking together of adhesive are limited. For example, it is known to apply a mesh or grating to the top opening of the tote in tote-based pneumatic fill systems to prevent clumps of adhesive from being poured into the tote during an operator refill. But such a mesh or grating only removes clumps that occur in bulk supply before the temporary storage within the tote. The clumping or sticking together of adhesive continues over time even after the adhesive solids are placed in the tote, as described above. The mesh or grate provides no solution for this ongoing problem. Therefore, the total storage capacity of totes in these fill systems has been limited or reduced in an attempt to avoid the clumping problem. Moreover, certain types of adhesive formulations (e.g., rubber-based) and adhesive solids defining less free-flowing particulate shapes have been considered unusable with tote-based pneumatic fill systems as a result of these deficiencies. Thus, the conventional tote-based fill systems cannot be used in many applications and continue to struggle with problems caused by clumping of adhesive solids and lack of air flow to the pump inlets.

There is a need, therefore, for improvements in hot melt adhesive systems, and specifically, a need for a fill system and method for use with a transfer pump that addresses present challenges and characteristics such as those discussed above.

### SUMMARY

According to one embodiment, a fill system is configured to retain and transfer adhesive solids to an adhesive melter. The fill system includes a storage container for containing a bulk supply of adhesive solids, and the storage container includes at least one sidewall and a bottom end. An agitator plate is positioned proximate the bottom end and is operatively coupled to a vibration generating mechanism. The vibration generating mechanism is configured to selectively vibrate the agitator plate to produce a relative motion of the agitator plate against a bottom surface of the bulk supply of adhesive solids. As a result of this relative motion, the bulk supply is agitated to separate adhesive solids and generate a flow of fluidized adhesive solids, at least a portion of which moves out of the storage container for transfer to the adhesive melter. The flow stops moving out of the storage container when the vibration generating mechanism stops vibrating the agitator plate.

For example, the adhesive solids within the storage container may define an angle of repose, defining the angle at which the adhesive solids will pile up when stationary. The storage container defines a gap adjacent the agitator plate in some embodiments, this gap being sized relative to the angle of repose such that adhesive solids cannot freely pour through the gap towards the adhesive melter absent the vibrations from the vibration generating mechanism. To this end, the angle of repose and the gap sizing acts as a valving mechanism for stopping the flow of fluidized adhesive solids when the vibration generating mechanism is inactive.

Consequently, the fill system provides a flow of fluidized adhesive solids on demand to the adhesive melter to avoid problems with clogging and starvation. The agitator plate includes a circular agitator disc in some embodiments. To this end, the agitator disc further includes an outer circumferential edge, a top surface facing towards the storage container, and an array of slots provided in the top surface. The slots are configured to increase agitation and separation of adhesive solids from the bulk supply when the agitator disc is vibrated. More particularly, the slots may be positioned so as to extend in a radial direction away from an axial center of the agitator disc and into intersection with an outer circumferential edge, thereby sifting the bulk supply of adhesive solids evenly across the bottom surface of the bulk supply. The slots define a depth that is less than half of an average particle diameter for the adhesive solids such that adhesive solids within the slots project upwardly from the top surface of the agitator disc to enhance agitation of the bulk supply. Thus, the slots improve the agitating efficiency of the agitator disc when vibrated.

The storage container is coupled to a plurality of support legs that support the storage container and the agitator plate, and therefore also the bulk supply of adhesive solids. To this end, the agitator plate is connected to the support legs with a plurality of connector devices that allow the agitator plate to vibrate or move relative to the storage container along multiple axes or directions. These connector devices may include various types of elements, including, but not limited to: universal joint members, springs, cables or rods, and similar couplings. It is possible in some embodiments for the connector devices to partially transmit a small amount of the vibrations applied to the agitator plate into the support legs and the storage container to discourage adhesion of adhesive solids to the storage container. However, additional features such as a non-stick coating on the sidewall of the storage container and an outward angling of the storage container sidewall are also used for similar purposes in these and other embodiments, regardless of whether any vibrations are actually transmitted through the connector devices to the storage container.

The vibration generating mechanism may include various types of mechanisms. In one aspect, an electric-actuated vibratory motor is connected to an underside of the agitator plate so that vibrations may be propagated throughout the agitator plate. The vibratory motor moves the agitator plate in a vertical direction as well as it moves and rotates the agitator plate in a horizontal direction. In another aspect, an air cylinder is engaged with a support bracket extending from the agitator plate. The air cylinder is repeatedly actuated to vibrate and rapidly rotate the agitator plate back and forth in opposing directions. Other types of vibration or movement generation devices may also be used, so long as the amplitude of vibrations applied to the agitator plate are sufficient to agitate the bulk supply and cause flow of fluidized adhesive solids around the outer peripheral edge portion of the agitator plate and into a pump inlet chamber.

The selective separation of adhesive solids from the bulk supply in the storage container and delivery of those adhesive solids into the pump inlet chamber enables pumps and melters to be adhesive fed on demand without air starvation or blockage occurring at pumps associated with the pump inlet chamber. To this end, the separation and supply of individual amounts of adhesive solids from a bulk supply into a pump inlet chamber avoids flooding of the pump inlet chamber which would typically lead to blockages and subsequent air starvation in the feed system. Accordingly, the fill system enhances the ability of pneumatic-based fill systems to reliably distribute and handle many distinct types of adhesive solids compositions in a plurality of operating conditions.

According to another embodiment of the invention, a method of transferring adhesive solids to an adhesive melter with a fill system is provided. The method includes storing a bulk supply of adhesive solids within a storage container including a bottom end. An agitator plate located adjacent to the bottom end is vibrated to produce relative motion against a bottom surface of the bulk supply of adhesive solids. This relative motion separates adhesive solids from the bulk supply, thereby generating a flow of fluidized adhesive solids, at least a portion of which moves out of the storage container. The method also includes stopping the flow of fluidized adhesive solids from exiting the storage container when the agitator plate stops vibrating. It will be appreciated that a residual amount of the flow of fluidized adhesive solids may continue for a brief period of time following the stopped movement of the agitator plate to allow for the adhesive solids to settle within the storage container to a static position (e.g., the flow continues until the adhesive solids assume their angle of repose again), but the flow usually stops quickly after stopping the vibration movement of the agitator plate.

In one aspect, vibrating the agitator plate further includes actuating an electric vibratory motor coupled to the agitator plate to generate vibration movement of the agitator plate along a vertical direction as well as movement and rotation along a horizontal direction. The bulk supply is agitated with this vibration, causing adhesive solids to separate or break apart from the bulk supply and form a flow that is capable of moving out of the storage container, at least while the agitator plate is vibrated. The vibrations are transmitted throughout the agitator plate to sift the bulk supply evenly across the bottom end. Moreover, some vibration may also transmit through the support legs into a sidewall of the storage container. In embodiments where the agitator plate includes an array of slots, vibrating the agitator plate causes a flow of fluidized adhesive solids to sit at least partially in the slots, so as to further transmit the vibration and enhance agitation of the bulk supply of adhesive solids.

When the agitator plate vibrates, the flow of fluidized adhesive solids is encouraged to move horizontally away from the bottom end of the storage container to flow around the peripheral edge of the agitator plate and into a pump inlet chamber. When the agitator plate stops vibrating, the angle of repose of the adhesive solids stops further flow of fluidized adhesive solids out of the storage container, as described briefly above. As a result, adhesive solids are delivered to the pump inlet chamber only on demand, thereby providing reliable supply of desired quantities of adhesive solids to a pump inlet chamber and avoiding problems caused by starvation and clogging of pumps.

These and other objects and advantages of the invention will become more readily apparent during the following detailed description taken in conjunction with the drawings herein.

### BRIEF DESCRIPTION OF THE DRAWINGS

The accompanying drawings, which are incorporated in and constitute a part of the specification, illustrate embodiments of the invention and, together with a general description of the invention given above, and the detailed description of the embodiments given below, serve to explain the principles of the invention.

FIG. 1 is a perspective view of a fill system for retaining and transferring adhesive solids to one or more melters, in accordance with a first embodiment of the invention, with a pump inlet chamber of the fill system shown in transparent to illustrate several internal features.

FIG. 2 is a top view of the fill system of FIG. 1, showing specific features of a storage container and agitator disc used with the fill system.

FIG. 3 is a schematic side cross-sectional view of a lower portion of the fill system of FIG. 1, taken along line 3-3 in FIG. 1.

FIG. 4 is a partially exploded perspective view of the agitator disc of FIGS. 1 and 2 and a vibration generating mechanism associated with the fill system and agitator disc.

FIG. 5 is a top view of the agitator disc of FIG. 4, illustrating the layout for an array of slots formed in the agitator disc.

FIG. 6 is a partially cross-sectioned detailed side view of the fill system of FIG. 1, showing the agitator disc spaced at a maximum spacing from a bottom end of the storage container with the flow of fluidized adhesive solids stopped from exiting the storage container when the agitator disc stops vibrating, as a result of the angle of repose assumed by the adhesive solids being greater than the gap angle defined by the flow gap or path exiting the storage container.

FIG. 7 is a partially cross-sectioned detailed side view similar to FIG. 6, showing the agitator disc moved to a minimum spacing from the bottom end of the storage container with a flow of fluidized adhesive solids moving beyond the agitator disc to exit the storage container during vibration of the agitator disc.

FIG. 8 is a cross-sectioned detailed side view of the fill system of FIG. 1, with the storage container shown in an empty state so as to reveal specific features of a universal joint used to couple the agitator disc to support legs which also support the storage container.

FIG. 9 is a cross-sectioned detailed side view similar to FIG. 8 of another embodiment of the fill system, with a cable or rod used to couple the agitator disc to support legs which also support the storage container.

FIG. 10 is a cross-sectioned detailed side view similar to FIG. 8 of another embodiment of the fill system, with a spring used to couple the agitator disc to support legs, which also support the storage container.

FIG. 11 is a side cross-sectional view of the fill system of FIG. 1, taken along line 3-3, and including a number of alternative structures and pump inlet clearing devices used in alternative embodiments of the fill system.

### DETAILED DESCRIPTION

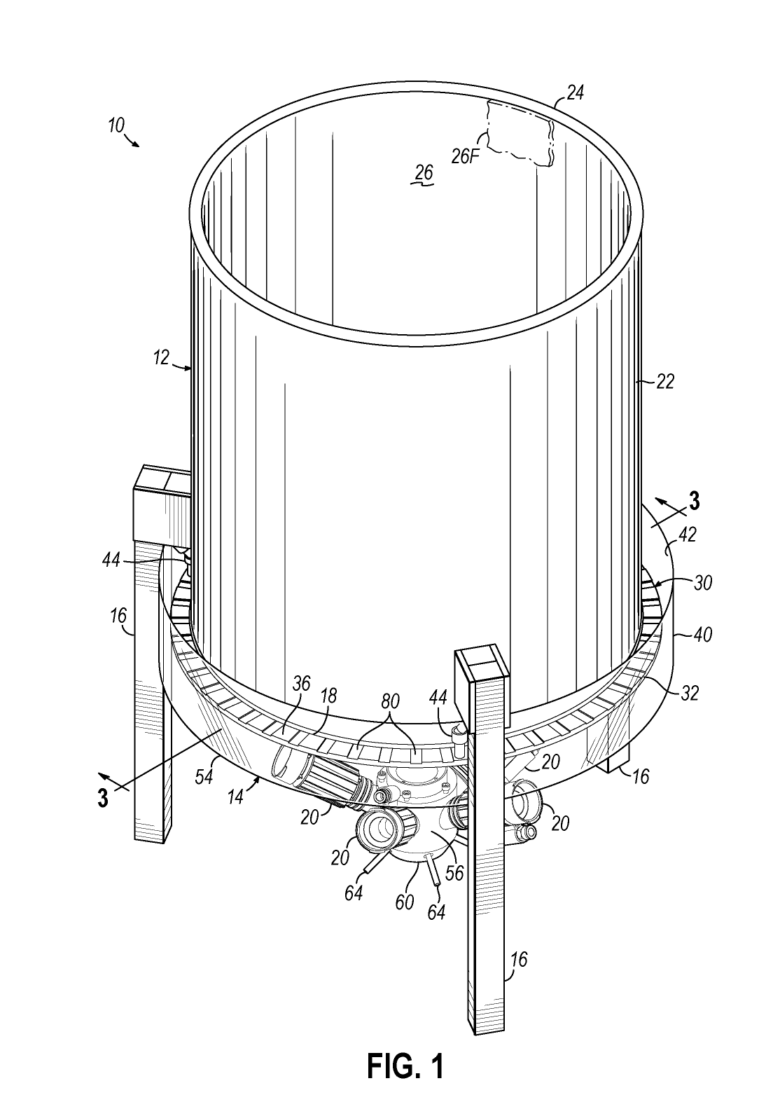

With reference to FIGS. 1 through 8, an exemplary embodiment of a fill system in accordance with the invention is shown in detail. To this end, the fill system generally includes a storage container that receives a bulk supply of adhesive solids, a separating element in the form of an agitator plate, and a drive that is configured to create relative movement between the agitator plate and a bottom surface of the bulk supply. For example, the agitator plate is configured to be vibrated to sift or grate along the bottom surface of the bulk supply, thereby separating adhesive solids from the bulk supply and generating a flow of fluidized adhesive solids. Consequently, most solidified masses of adhesive (which could otherwise clog pump inlets or conduits downstream) are broken up or blocked from flowing out of the storage container. Accordingly, the fill system improves the reliability and operational performance of adhesive fill systems by reducing the likelihood of problems such as pump inlet flooding, air starvation at the pump, and pump clogging.

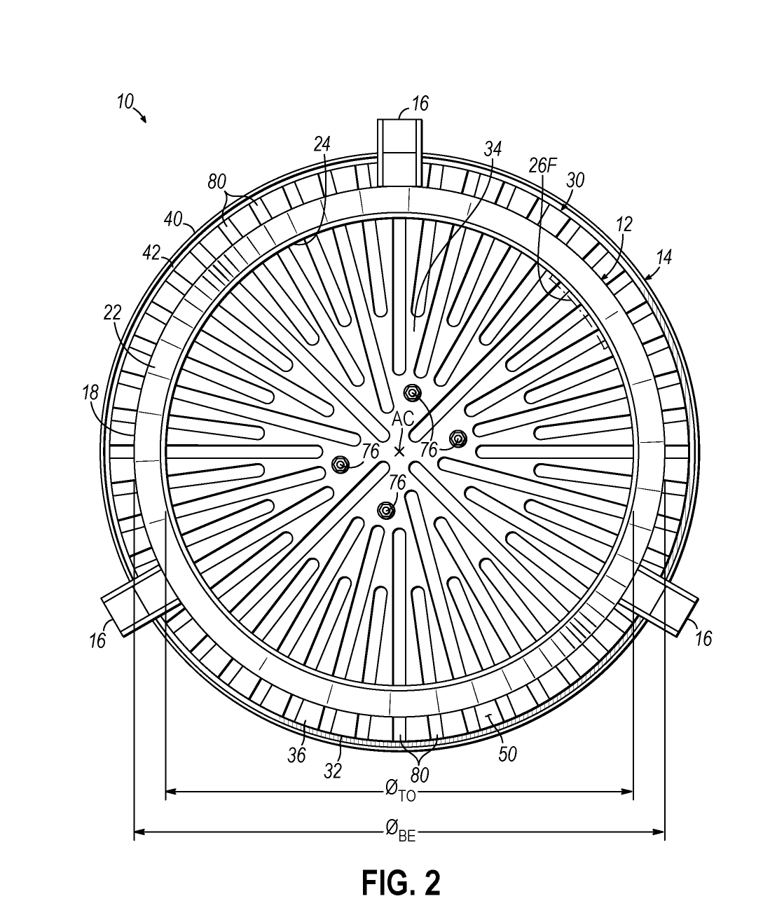

With particular reference to FIGS. 1 and 2, the exemplary embodiment of the fill system 10 includes a storage container 12 positioned directly above a pump inlet chamber 14. The storage container 12 and the pump inlet chamber 14 are each supported by a plurality of support legs 16 coupled to and extending downwardly from a bottom end 18 of the storage container 12. More particularly, three support legs 16 are shown in the exemplary embodiment. It will be understood that the specific number of support legs 16 and the method of coupling to the bottom end 18 of the storage container 12 may be modified from what is shown in these figures without departing from the scope of the invention.

The storage container 12 receives a bulk supply of adhesive solids (such as solid adhesive particulate) which may be selectively transferred into the pump inlet chamber 14 for delivery to a plurality of pumps 20 communicating with the pump inlet chamber 14. The pump inlet chamber 14 is shown generally transparent in FIG. 1 to reveal the pumps 20 and the agitator plate (described further below), but it will be understood that the pump inlet chamber 14 may be non-transparent in actual embodiments of the fill system 10. Each of the pumps 20 is typically paired with a corresponding single melter (not shown) and supplies adhesive solids to that melter only. Consequently, the storage container 12 is sized to receive a sufficient supply of adhesive to feed the plurality of pumps 20 for a number of hours during normal operation without requiring manual intervention or refill. For example, the storage container 12 in the exemplary embodiment contains up to 150 pounds of adhesive solids when the melters and pumps 20 are configured to receive, on average, up to 5 pounds of adhesive per hour in normal operation (and on average, collectively up to 20 pounds per hour, or 7-8 hours of operation without intervention). Of course, if demands from the pumps 20 are increased or decreased, the frequency at which the fill system 10 will require refilling will vary accordingly.

The storage container 12 includes a stationary sidewall 22 defining a generally circular cross section from a top opening 24 to the bottom end 18. The stationary sidewall 22 defines an interior surface 26 that faces towards the bulk supply of adhesive solids received within the storage container 12. This interior surface 26 is advantageously formed from or coated with a friction reducing material such as polytetrafluoroethylene or polyethylene. Alternatively, a fabric liner (a portion of which is shown in phantom at reference 26F in FIG. 2) formed from a heavy canvas or tarp-like material, such as nylon-based fabrics commercially available under the brand Cordura® in one example, may be loosely fitted to the interior surface 26 and therefore configured to flex to release adhesive solids moving downwardly through the storage container 12. In addition, or alternatively in some embodiments, the stationary sidewall 22 is angled slightly outwardly from the top opening 24 to the bottom end 18 such that the top opening 24 is smaller in cross-sectional size than the bottom end 18. This tapering of the storage container 12 towards the top opening 24 is shown most clearly in the top-down view FIG. 2, more specifically by the smaller diameter Ø_{TO} defined at the top opening 24 as compared to the larger diameter Ø_{BE} defined at the bottom end 18. Consequently, gravitational forces acting on the bulk supply of adhesive solids do not tend to push those adhesive solids into contact with the sidewall 22 of the storage container 12. The friction reducing material and the angling of the sidewall 22, either alone or in combination, serve to promote downward flow of adhesive solids towards the bottom end 18. In this regard, the risk of adhesive solids wedging within the storage container 12 or solidifying along the stationary sidewall 22 is reduced compared to conventional fill system designs.

The top opening 24 is shown without a cover in FIG. 1, but it will be understood that such could be provided to eliminate adhesive contamination. The bottom end 18 of the storage container 12 is also designed to be open for the reasons set forth in detail below.

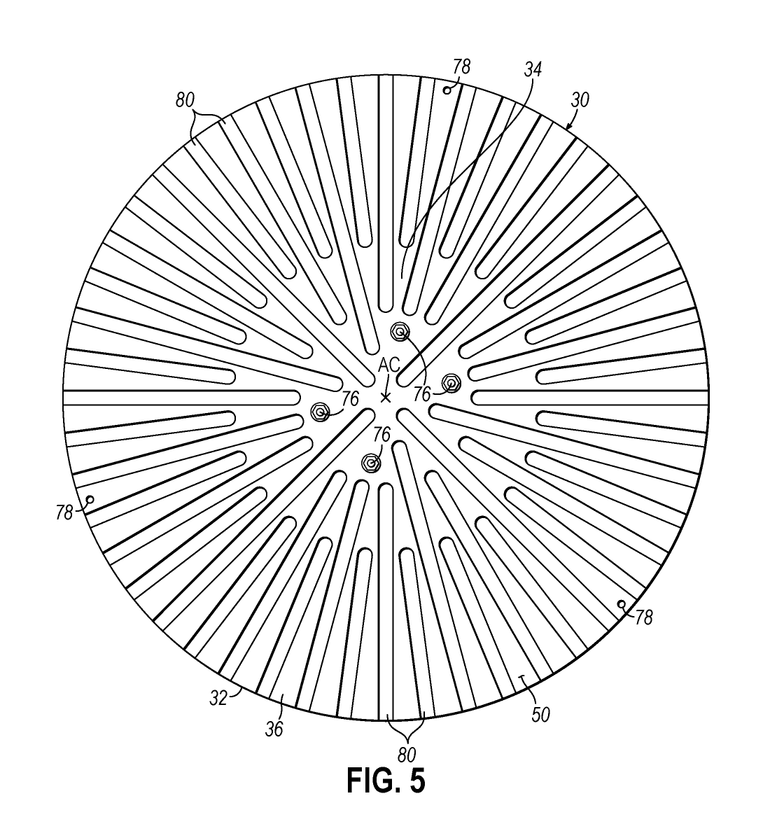

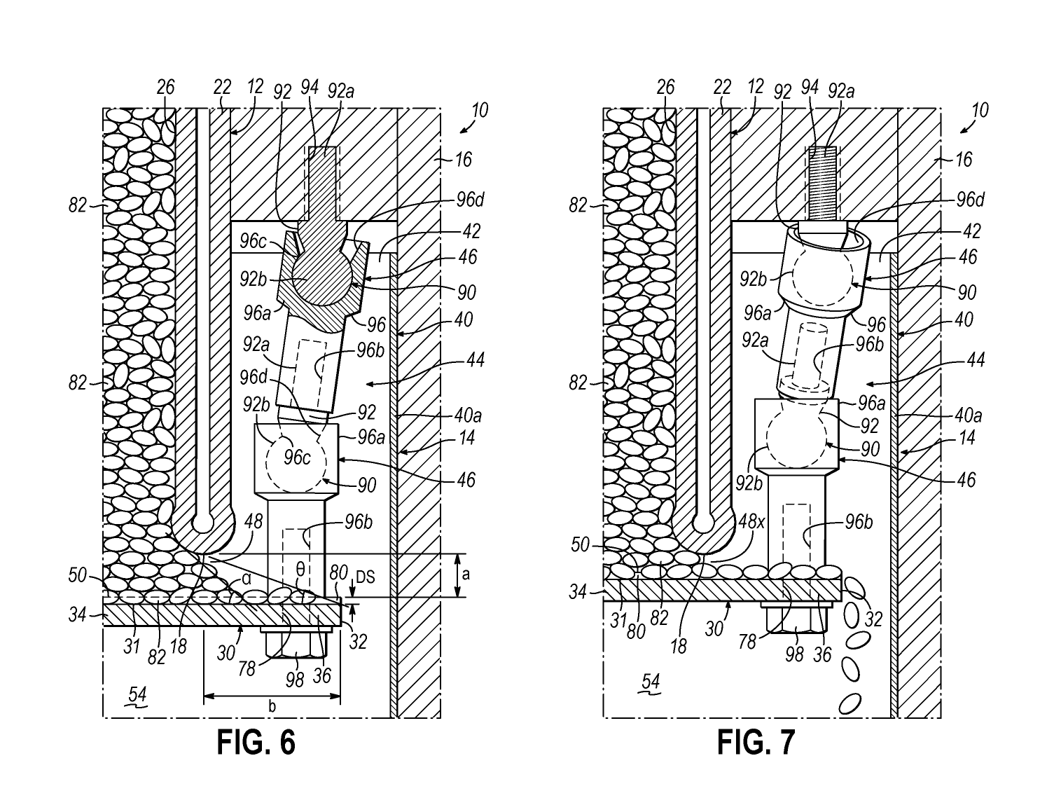

As shown most clearly in FIGS. 1 through 3, the fill system 10 also includes an agitator plate 30 located proximate to the bottom end 18 of the storage container 12. The agitator plate 30 is mounted as a type of floating plate, which means the agitator plate 30 is supported so as to enable movement relative to the bottom end 18 of the storage container 12, when the agitator plate 30 is vibrating. The agitator plate 30 may also be referred to as a sifter plate in some embodiments. To this end, the agitator plate 30, at least when it is not active, effectively closes off or occludes the bottom end 18 of the storage container 12 so that the bulk supply of adhesive solids does not uncontrollably feed into the pump inlet chamber 14. The agitator plate 30 engages with a bottom surface 31 of the bulk supply of adhesive solids (not shown except at FIGS. 6 and 7) to control flow of fluidized adhesive solids between the storage container 12 and the pump inlet chamber 14. More specifically, the agitator plate 30 may be vibrated or otherwise moved to generate and move the flow of fluidized adhesive solids out of the storage container 12.

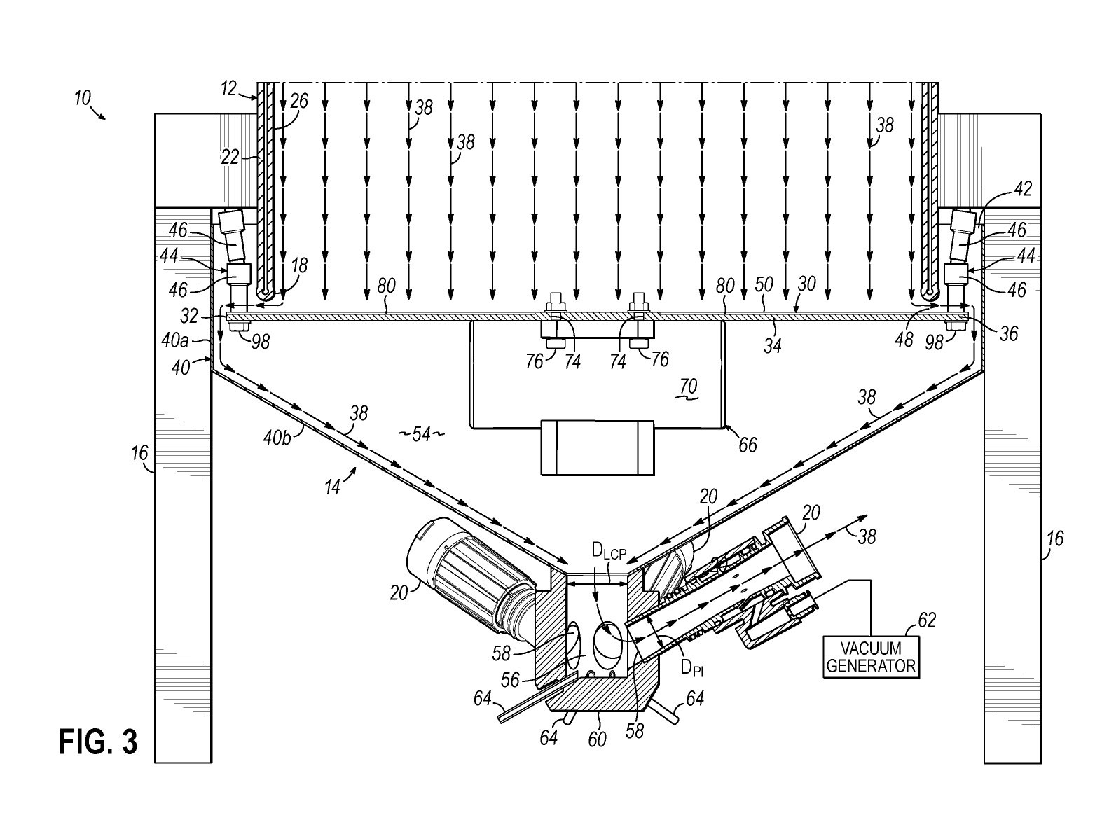

The agitator plate 30 is larger in diameter than the bottom end 18 of the storage container 12, which prevents the adhesive solids from continuously flowing around or applying pressure to an outermost peripheral edge 32 defined by the agitator plate 30. In this regard, the agitator plate 30 effectively defines a central plate portion 34 covering the bottom end 18 and an outer peripheral edge portion 36 extending radially beyond the central plate portion 34 and beyond the bottom end 18 of the storage container 12. When the agitator plate 30 of this embodiment vibrates to sift or grate the bottom surface 31 of the bulk supply of adhesive solids, the resulting flow of fluidized adhesive solids separated from the bulk supply moves around the outermost peripheral edge 32 and into the pump inlet chamber 14 (shown by flow arrows 38 in FIG. 3). As a result, the agitator plate 30 of this embodiment is a circular agitator disc 30, although it will be understood that other shapes and cross-sectional configurations of the agitator plate 30 are possible in other embodiments consistent with the scope of the invention. The specific sifting operation of the agitator plate 30 is described in further detail with reference to FIGS. 6 and 7 below.

As shown in FIGS. 2 and 3, the support legs 16 also support a chamber sidewall 40 of the pump inlet chamber 14 as well as the agitator plate 30 in this exemplary embodiment. In this regard, the chamber sidewall 40 is larger in circumference than the agitator plate 30 at a location adjacent to the agitator plate 30 so that the chamber sidewall 40 radially surrounds or circumscribes the agitator plate 30 along a horizontal plane. This larger size enables a flow path for the flow of fluidized adhesive solids to move out of the storage container 12 and into the pump inlet chamber 14 between the sidewall 40 and the agitator plate 30 (as shown by the flow arrows 38 previously indicated). The chamber sidewall 40 terminates above the bottom end 18 of the storage container 12 to prevent adhesive solids from flowing out of the fill system 10 through an opening 42 defined between the chamber sidewall 40 and the sidewall 22 of the storage container 12 when the flow of fluidized adhesive solids exits the storage container 12. This opening 42 also provides clearance for a plurality of connector devices 44 to extend between the support legs 16 and the outer peripheral edge portion 36 of the agitator disc 30, for reasons set forth below. However, it will be appreciated that this opening 42 between the chamber sidewall 40 and the sidewall 22 of the storage container 12 may be largely closed by a radial connector wall (not shown) in other embodiments without departing from the scope of the present invention.

The connector devices 44 of the exemplary embodiment that are shown in FIG. 3 couple the agitator plate 30 to the support legs 16. More particularly, the connector devices 44 are configured to support the agitator plate 30 in such a manner that the agitator plate 30 is free to vibrate or move relative to the bottom end 18 of the storage container 12 (and therefore also move relative to the bottom surface 31 of the bulk supply of adhesive solids). Each of the connector devices 44 includes a series of universal joint members 46 that collectively enable freedom of movement in three dimensions for the agitator plate 30. To this end, the agitator plate 30 is free to move and rotate along horizontal and vertical directions as a result of the vibrations applied to the agitator plate 30. Of course, it will be understood that the movement of the agitator plate 30 may also be partially delimited by the universal joint members 46 so as to define minimum and maximum spacing from the bottom end 18 of the storage container 12, but these limits are described more fully with reference to FIGS. 6 and 7 below. The connector devices 44 may also be replaced with other types of members as described in alternative embodiments below. In addition to ensuring the freedom of movement for the agitator plate 30, the connector devices 44 are also designed to reliably hold the agitator plate 30 in position to sift the bottom surface 31 of the bulk supply, even when the storage container 12 is fully loaded with the bulk supply (which sits largely or entirely on top of the agitator plate 30) and even when the agitator plate 30 is vibrated.

The agitator plate 30 is therefore positioned by the connector devices 44 within the chamber sidewall 40 so as to form a (maximum) nominal gap 48 (“nominal” is used throughout to define a state when the agitator plate 30 is not moving) between a top surface 50 of the agitator plate 30 and the bottom end 18 of the storage container 12. The nominal gap 48 is sized to be large enough to enable selective flow of the adhesive solids out of the storage container 12 and into the pump inlet chamber 14 whenever the agitator plate 30 is vibrated. However, as described in further detail below, the maximum nominal gap 48 is also sized to restrict and stop the flow of fluidized adhesive solids out of the storage container 12 when the agitator plate 30 stops moving. Thus, the specific positioning of the agitator plate 30 caused by the connector devices 44 and the support legs 16 provides the ability to deliver adhesive solids on demand to the pump inlet chamber 14 from the storage container 12.

As described above, the chamber sidewall 40 defines a portion of the pump inlet chamber 14, which is shown in cross section in FIG. 3. More specifically, the chamber sidewall 40 defines an upper chamber portion 54 that extends downwardly from the bottom end 18 of the storage container 12 to a lower chamber portion 56 located beneath the upper chamber portion 54. The lower chamber portion 56 is generally cylindrical and smaller in size than the upper chamber portion 54. Thus, the upper chamber portion 54 is generally cylindrical along a first sidewall portion 40a of the chamber sidewall 40 and then becomes funnel-shaped along a second sidewall portion 40b of the chamber sidewall 40. Both of the first and second sidewall portions 40a, 40b may include walls that are formed from or coated with friction reducing materials, similar to the stationary sidewall 22 of the storage container 12 described above. As a result, the flow of fluidized adhesive solids that exits the storage container 12 is funneled by the upper chamber portion 54 into the lower chamber portion 56 without allowing the adhesive solids to collect or stick together on the chamber sidewall 40.

The lower chamber portion 56 communicates with the plurality of pumps 20, which are shown as five pumps 20 in the illustrated embodiment (not all five pumps 20 can be viewed in any one perspective). However, it will be understood that one or more of these pumps 20 could be removed and the corresponding pump inlets 58 plugged when fewer than five pumps 20 are to be used with the pump inlet chamber 14. As shown in FIG. 3, the lower chamber portion 56 of the pump inlet chamber 14 in the exemplary embodiment is sized as a cylindrical space having a diameter D_{LCP} approximately equal in size to the diameter D_{PI} of pump inlets 58 communicating with the lower chamber portion 56. This approximate equivalence in diameters improves the operational efficiency or performance of drawing adhesive solids into and through the inlets 58 when required for delivery to the associated melters and dispensing units. Each of the pumps 20 is mounted to the lower chamber portion 56 so that the pumps 20 and the inlets 58 angle upwardly from a bottom end 60 of the lower chamber portion 56. The adhesive solids flowing into the lower chamber portion 56 are deposited onto the bottom end 60, which is adjacent to the inlets 58 of the pumps 20. The upward angling of the pumps 20 ensures that adhesive solids do not flow or migrate in large quantities into the inlets 58 of pumps 20 that are currently not operating. As a result, blockages caused by adhesive solids coalescing into solidified masses within the inlets 58 are minimized during operation.

The pumps 20 used with this embodiment of the fill system 10 are Venturi type pumps 20 that generate a vacuum upstream of the orifices and positive pressure downstream of the orifices in order to move adhesive solids. These types of pumps 20 are largely known in the art and are not described in detail below. In addition, the fill system 10 may include a mechanism for clearing out the adhesive solids in the lower chamber portion 56 between operational cycles of the pumps 20. In one simplified example used with the exemplary embodiment, the pump inlet clearing device includes a Venturi type pump 20 that is dedicated for clearing residual adhesive solids out of the lower chamber portion 56 near the pump inlets after each fill cycle. These residual adhesive solids may be directed back to the bulk supply container 12. In addition, the capability of the Venturi type pump may be supplemented by an axial eductor 64 aligned with the pump inlets.

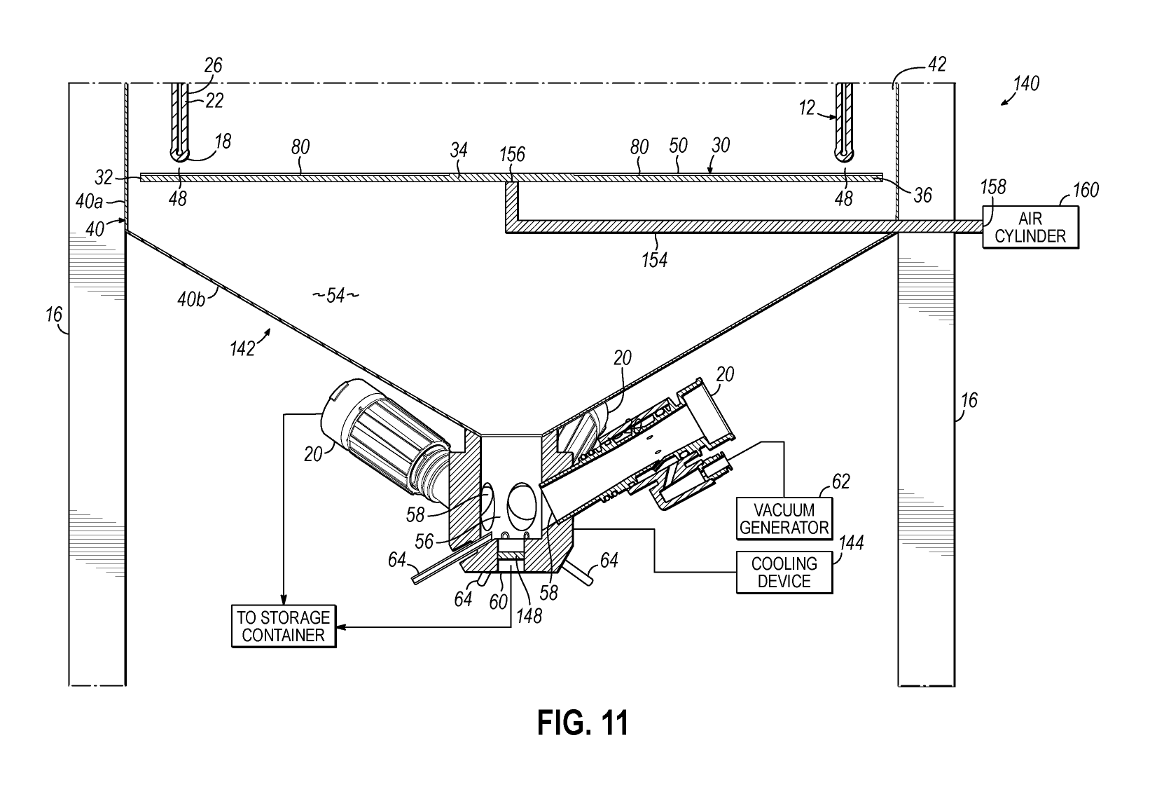

The vacuum generators 62 defined by the pumps 20 produce a suction force upstream of the orifices they are connected to, such as by creating negative pressure upstream from where pressurized air is injected to create a Venturi effect, this suction force drawing adhesive solids out of the lower chamber portion 56 and through the pump 20. Similarly, the eductors 64 produce a blast of air or a compressed air jet across the lower chamber portion 56 that pushes on adhesive solids to move those adhesive solids into and through the inlets 58 and the pumps 20. When the vacuum generators 62 and the eductors 64 are used in combination, the operation of each pump 20 more quickly empties the lower chamber portion 56, but it will be understood that one of these elements may be omitted in other embodiments of the fill system 10. For example, other types of devices may also be included as clearing devices for the lower chamber portion 56 in alternative embodiments, as described with reference to FIG. 11 below. Also, the eductors 64 (in another example) act as agitation devices that can remove adhesive solids from the lower chamber portion 56 between dispensing cycles as set forth in further detail below. Regardless of the particular pump inlet clearing devices used in the fill system 10, the lower chamber portion 56 can be positively cleared from adhesive solids at the bottom end 60 thereof before and/or during periods of inactivity of the pumps 20 and of the agitator plate 30, thereby avoiding solidification of adhesive within the lower chamber portion 56 that can lead to blockages of the pump inlets 58.

The general operation of the fill system 10 is summarized as shown by the flow arrows 38 in FIG. 3. In this regard, the agitator plate 30 is moved by a vibration generating mechanism in the form of an electric-actuated vibratory motor 66 (the “drive” referred to above) coupled to the agitator plate 30. The vibrations of the agitator plate 30 agitate the bottom surface 31 of the bulk supply in a sifting or grating-type motion to separate some adhesive solids from the bulk supply within the storage container 12. As a result, these adhesive solids flow downwardly through the storage container 12 and around the outermost peripheral edge 32 of the agitator plate 30 into the pump inlet chamber 14. As the agitator plate 30 is a solid member, the flow of fluidized adhesive solids is forced to move horizontally through the gap 48 before exiting the storage container 12. Accordingly, the relationship between the agitator plate 30 and the bottom end 18 of the storage container 12 effectively restricts the flow of fluidized adhesive solids such that the flow occurs only when the vibrations in the agitator plate 30 encourage horizontal movement of adhesive solids through the gap 48.

Once the vibrations of the agitator plate 30 stop, the flow of fluidized adhesive solids into the pump inlet chamber 14 also stops, so the flow of fluidized adhesive solids is delivered only on demand when needed by the pumps 20. It will be understood that a residual amount of the flow of fluidized adhesive solids may continue for a brief period of time following the stopped movement of the agitator plate 30 to allow for the adhesive solids to settle within the storage container 12. After the flow of fluidized adhesive solids (again, represented by flow arrows 38 in FIG. 3) moves through the upper chamber portion 54 and into the lower chamber portion 56, the pumps 20 use vacuum force or the eductors 64 to draw and push the adhesive solids through the pump inlets 58 to empty the bottom end 60 of the pump inlet chamber 14. Thus, the pump inlet chamber 14 can be maintained in an empty state between operating cycles of the pumps 20, thereby eliminating stagnation and coalescing of adhesive solids within the pump inlet chamber 14. Additional features and functionality of the agitator plate 30 and the associated drive are now described in detail below.

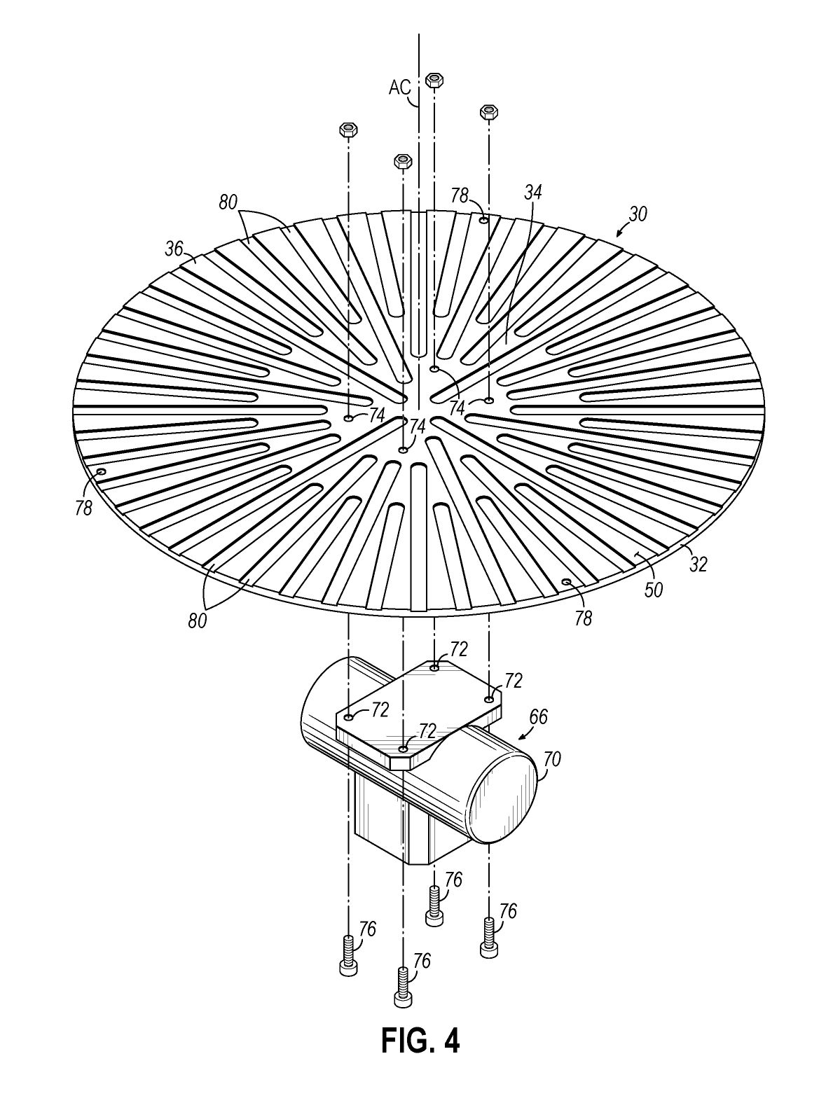

With specific reference to FIGS. 4 and 5, the agitator plate 30 is shown in further detail. More particularly, an assembly of the agitator plate 30 and the vibrator motor 66 used as the drive in the exemplary embodiment is shown in partially exploded view in FIG. 4. The vibrator motor 66 includes a motor casing 70 enclosing a motor or any similar known mechanism for generating and transmitting vibration energy to elements coupled to the motor casing 70. These vibration generators are known in the industry and therefore further explanation of these possible structures is not necessary herein. The motor casing 70 of the exemplary embodiment is sized smaller than the agitator plate 30 and is therefore configured to be coupled to the agitator plate 30 along the central plate portion 34.

To this end, the motor casing 70 includes a plurality of fastener apertures 72 facing upwardly towards the agitator plate 30 and the central plate portion 34 of the agitator plate 30 includes a corresponding plurality of central fastener apertures 74 extending through the thickness of the agitator plate 30. These fastener apertures 72, 74 may be aligned with one another such that threaded fasteners 76 may be inserted to rigidly couple the vibrator motor 66 to the agitator plate 30. Other types of fasteners or fastening devices may be used to couple the motor casing 70 and the agitator plate 30 in other embodiments without departing from the scope of the present invention. By positioning the vibrator motor 66 near a center of the agitator plate 30, the vibrator motor 66 is able to propagate vibrations throughout the entirety of the agitator plate 30, thereby agitating the bottom surface 31 of the bulk supply of adhesive solids along an entire top surface 50 of the agitator plate 30. The vibrations generally move and rotate the agitator plate 30 in a chaotic or random manner along horizontal and vertical directions when the universal joint members 46 are used as the connector devices 44 for supporting the agitator plate 30 in this embodiment.

The agitator plate 30 also includes outer fastener apertures 78 located adjacent to the outermost peripheral edge 32 as shown in FIGS. 4 and 5. These outer fastener apertures 78 are configured to receive fastening portions of the connector devices 44 as described in further detail below. Consequently, the various fastener apertures 74, 78 provided through the thickness of the agitator plate 30 enable different types of connector devices 44 and different sizes or types of drives to be coupled to the agitator plate 30, which is advantageous because different levels of vibration and different types of movement (horizontal/vertical/both) may be desired for different types of adhesive solids being stored in the storage container 12. In this regard, the agitator plate 30 is adapted for use with many different types of adhesive solids having different pellet shapes, sizes, and adhesive formulations. Of course, the various apertures 74, 78 in the agitator plate 30 could be repositioned in other embodiments consistent with the invention.

The agitator plate 30 is a circular agitator disc 30 as previously described, but this agitator plate 30 includes no apertures through the thickness thereof for transferring the flow of fluidized adhesive solids into the pump inlet chamber 14. Instead, the top surface 50 of the agitator plate 30 defines a contoured surface configured to enhance the agitation caused along the bottom surface 31 of the bulk supply when the agitator plate 30 vibrates. More specifically, the agitator plate 30 of the exemplary embodiment includes an array of slots 80 cut partially through the thickness of the agitator plate 30 at the top surface 50. For example, these slots 80 may be milled outwardly from the central plate portion 34 to intersect with the outermost peripheral edge 32 of the agitator plate 30. The slots 80 are positioned along substantially the entire top surface 50 so that the enhanced agitation of the bulk supply is provided along the entirety of the agitator plate 30. As a result, separated adhesive solids are encouraged to flow radially outwardly out of the storage container 12 by the vibrations applied to the agitator plate 30, including even those adhesive solids located near an axial center AC of the agitator plate 30.

In the exemplary embodiment shown most clearly in FIG. 5, each of the slots 80 is oriented along radial lines extending outwardly from the axial center AC of the agitator plate 30. In order to fit a maximum number of these radially-oriented slots 80 on the top surface 50, several of the slots 80 define longer lengths (and begin closer to the axial center AC) than others. Nevertheless, each of the slots 80 is cut so as to intersect the outermost peripheral edge 32 of the agitator plate 30 so that adhesive solids located at least partially within the slots 80 are able to be vibrated through the length of the slots 80 and out of the storage container 12.

The slots 80 define a thickness or depth DS (shown in FIG. 6) that is less than the total thickness of the agitator plate 30 (as alluded to above) and also less than an average particle diameter defined by the adhesive solids 82. For example, the depth DS of the slots 80 is about 1/16 inches in the exemplary embodiment for an average particle diameter of the adhesive solids 82 of about 3/16 inch. As shown in FIG. 6, this sizing of the slots 80 allows for only a partial portion of adhesive solids 82 at the bottom surface 31 of the bulk supply to reside within the slots 80. Consequently, each of the adhesive solids 82 within the slots 80 projects upwardly from the top surface 50 of the agitator plate 30, and the adhesive solids 82 individually act as additional agitators extending further into the bulk supply than the agitator plate 30 does. Hence, the slots 80 and the adhesive solids 82 contained partially therein increase or enhance the amount of agitation provided to the bulk supply to more reliably break apart clumps of adhesive and cause the flow of fluidized adhesive solids 82 to move out of the storage container 12 during vibration of the agitator plate 30. Furthermore, none of the adhesive solids 82 become trapped in the slots 80 on the agitator plate 30 as a result of the relative sizing described above. It will be understood that the specific slot depth DS may be modified when different types of adhesive are used in fill systems 10 of other embodiments.

With continued reference to FIGS. 6 and 7, the sifting operation applied to remove adhesive solids 82 from the storage container 12 is shown in further detail. To this end, when the agitator plate 30 vibrates to agitate the bulk supply and form a flow of fluidized adhesive solids 82, the flow can only escape the storage container 12 by moving horizontally through the gap 48 previously described between the bottom end 18 of the storage container 12 and the top surface 50 of the agitator plate 30. This flow is stopped when the vibrations of the agitator plate 30 stop, as shown in the state of FIG. 6. When the agitator plate 30 is vibrated as shown in the state of FIG. 7, adhesive solids flow so as to roll over the outermost peripheral edge 32 of the agitator plate 30 and into the pump inlet chamber 14.

As described briefly above, the gap 48 is sized so as to restrict the flow of fluidized adhesive solids 82 when the agitator plate 30 is not moving. More specifically, the gap 48 is sized relative to the angle of repose defined by the adhesive solids 82 being retained within the storage container 12 such that flow of fluidized adhesive solids 82 is stopped when the agitator plate 30 is not vibrating. This stopped flow state is shown in FIG. 6, for example. As shown in that Figure, the adhesive solids 82 flow when unrestricted to make a radially sloped pile beneath the bottom end 18 of the storage container 12 with sides defined by an angle of repose from the support surface (in this case, the angle of repose (α) is measured from the top surface 50 of agitator plate 30). The nominal gap 48 (i.e., a maximum gap when the agitator plate 30 is stationary) provided between the bottom end 18 and the agitator plate 30 is dimensioned such that adhesive solids 82 flowing from the bottom end 18 of the storage container 12 and onto the outer peripheral edge portion 36 of the agitator plate 30 will not reach the outermost peripheral edge 32 of the agitator plate 30. Instead, the flow of fluidized adhesive solids 82 will terminate with the pile formed by the bulk supply on top of the agitator plate 30 defining the angle of repose (α) for the adhesive solids 82 adjacent to the gap 48. Until the agitator plate 30 is vibrated by the drive once again, the adhesive solids 82 will remain in the steady state shown in FIG. 6, which means the flow can be selectively stopped when the pumps 20 in the pump inlet chamber 14 do not require adhesive solids 82.

One example of the relevant angles and distances defined by the nominal gap 48 at the bottom end 18 of the storage container 12 and the agitator plate 30 is shown in FIG. 6. To this end, the gap 48 is defined by “a” and “b” distances, which correspond to (“a”) the height of the gap 48 measured between the bottom end 18 and the top surface 50, and (“b”) the length of the outer peripheral edge portion 36 located beyond the outer circumference of the bottom end 18 of the storage container 12. In the exemplary embodiment, the “a” distance is about 0.5 inch and the “b” distance is about 1.5 inches, which generates a gap angle (θ) of about 20 degrees (these distances and angles may not be shown to scale in the FIGS.). By contrast, a typical angle of repose (α) for the adhesive solids 82 is larger, such as 30 to 40 degrees. In view of the smaller angle or larger horizontal distance defined by the gap angle (θ) compared to the angle of repose (α), the adhesive solids 82 pile up and stop flowing at a location short of the outermost peripheral edge 32. Therefore, the restriction of flow caused by the nominal gap 48 terminates flow of the adhesive solids 82 when the agitator plate 30 is not vibrating. Furthermore, this flow is terminated within a short period of time after the vibratory motor 66 stops operating, and this is considered to be “stopping the flow of fluidized adhesive solids 82” when the agitator plate 30 stops vibrating.

It will be understood that the specific angles and “a” and “b” dimensions provided above are exemplary only and may be modified to suit the needs of the end user of the fill system 10. For example, some adhesive compositions and pellet shapes define different angles of repose, and the gap 48 can be adjusted by modifying the “a” and “b” distances to assure restriction of flow of fluidized adhesive solids 82 between vibration movements of the agitator plate 30. Indeed, the combination of selective sifting of the bulk supply using the relative motion produced by the agitator plate 30 and restriction of flow of fluidized adhesive solids 82 based on the angle of repose contributes to the advantageous operation of the fill system 10, which minimizes adhesive clumps and blockage issues in the pump inlet chamber 14 by delivering adhesive only on demand.

As shown schematically in FIG. 7, starting vibrations of the agitator plate 30 with the vibratory motor 66 will agitate the bulk supply of adhesive solids 82 and once again cause the flow of fluidized adhesive solids 82 to move horizontally through the gap 48 and out of the storage container 12. The adhesive solids 82 tumble out of the slots 80 and off of the top surface 50 of the agitator plate 30 at the outermost peripheral edge 32 as shown and then drop vertically into the upper chamber portion 54 of the pump inlet chamber 14. As discussed above, the vibrations of the agitator plate 30 cause horizontal and vertical movement of the agitator plate 30 relative to the bottom end 18 of the storage container 12 thanks to the freedom of movement enabled by the connector devices 44. For example, the connector devices 44 allow the agitator plate 30 to move randomly or chaotically between a maximum spacing from the bottom end 18 (e.g., the nominal gap 48 shown in FIG. 6) to a minimum spacing closer to the bottom end 18 of the storage container 12 (e.g., the smaller gap 48x shown in FIG. 7). As shown in FIGS. 6 and 7, the minimum spacing or smaller gap 48x still enables adhesive solids 82 to move between the agitator plate 30 and the bottom end 18, while the maximum spacing of nominal gap 48 remains sized to restrict or stop flow of fluidized adhesive solids 82 when the agitator plate 30 stops vibrating. The bottom end 18 of the storage container 12 may also be rounded as shown in these FIGS. to encourage continued flow of fluidized adhesive solids 82 even when the agitator plate 30 temporarily reaches the minimum spacing shown in FIG. 7. It will be appreciated that the sizes of the minimum and maximum spacing or gaps 48, 48x allowed by the connector devices 44 may be modified in other embodiments depending on the needs and preferences of the end user.

In the exemplary embodiment, these minimum and maximum spacings are determined by the freedom of movement offered at the universal joint members 46, which are shown in further detail in FIGS. 6 through 8. To this end, the connector device 44 shown in the exemplary embodiment defines two ball-in-socket joints 90 formed between corresponding universal joint members 46. More specifically, the connector device 44 includes a first pin member 92 including a threaded end 92a engaged with a threaded aperture 94 in the support leg 16 and a ball 92b opposite the threaded end 92a. The connector device 44 also includes a first socket member 96 which is elongated and includes a cup-shaped socket 96a on one end and a threaded aperture 96b extending inwardly from an opposite end. The cup-shaped socket 96a is sized to closely receive and retain the ball 92b of the first pin member 92. Moreover, the cup-shaped socket 96a defines an internal shoulder 96c that snaps over the ball 92b to reliably retain the connection between the first pin member 92 and the first socket member 96 regardless of the angling between these elements. The opening 96d located beyond the internal shoulder 96c is sized to limit how far the first socket member 96 can pivot or rotate relative to the first pin member 92, as will be understood from the views in FIGS. 6 and 7.

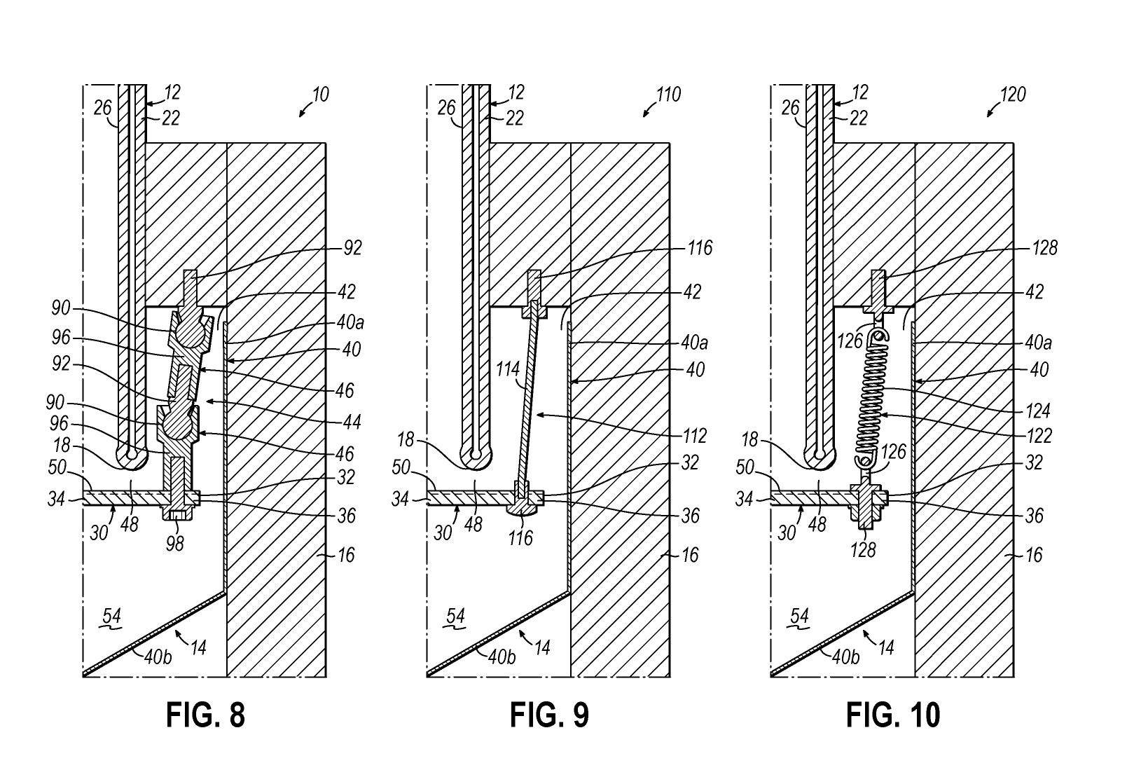

The connector device 44 of the exemplary embodiment also includes a second pin member 92 identical to the first pin member 92 and having the threaded end 92a thereof engaged rigidly with the threaded aperture 96b of the first socket member 96. The ball 92b of the second pin member 92 is engaged with a socket 96a of a second socket member 96 identical to the first socket member 96 and located below the second pin member 92. The threaded aperture 96b of this second socket member 96 is engaged with a threaded fastener 98 extending upwardly through the outer fastener aperture 78 located in the agitator plate 30. Thus, the second socket member 96 is rigidly coupled to the agitator plate 30. These engagements are shown most clearly in the cross-sectional view of FIG. 8, for example. Each of the universal joint members 46 may be considered to include one of the pin members 92 and one of the socket members 96. It will be appreciated that more or fewer universal joint members 46 may be used for each connector device 44 supporting the agitator plate 30, in order to provide different numbers of ball-in-socket joints 90 and different capabilities of the agitator plate 30 to move relative to the bottom end 18 of the storage container 12 in other embodiments. However, any embodiment including universal joint member(s) 46 for the connector devices 44 will enable at least some movement in all three dimensions for the agitator plate 30.

Another benefit of the close engagement formed between the universal joint members 46 is the potential transfer of partial portions of the vibration energy out of the agitator plate 30. In this regard, some of the vibrations transmitted to the outer peripheral edge portion 36 of the agitator plate 30 can propagate through the universal joint members 46 into the support legs 16 and then into the sidewall 22 of the storage container 12. Advantageously, such vibrations applied to the sidewall 22 further discourage adhesion of adhesive solids 82 to the sidewall 22 as gravity moves the adhesive solids 82 downwardly towards the agitator plate 30. These transmitted vibrations of the exemplary embodiment cooperate with the friction-reducing coating and the outward angling of the sidewall 22 to limit or eliminate adhesion of the bulk supply to the storage container 12 in the fill system 10. However, it will be understood that the vibrations of the agitator plate 30 do not need to be transmitted through the connector devices 44 in all embodiments of the fill system 10.

Consequently, the exemplary embodiment of the fill system 10 described above is capable of supplying adhesive solids 82 on demand to pneumatic pumps 20 or other supply mechanisms used with adhesive melters and dispensing units. The fill system 10 enables adhesives of all types of formulations, including the more malleable adhesives like rubber-based formulations, to be supplied to the melters. As a result of the relative movement or sifting action generated by the fill system 10, even adhesive solids 82 that are known to be non-free flowing can be supplied without significant manual or operator intervention. Furthermore, the fill system 10 may be used in non-favorable system environments such as those with higher ambient temperatures. Thus, the fill system 10 described herein improves the efficiency and the autonomous nature of current adhesive dispensing systems.

With reference to FIGS. 8 through 10, alternative designs for the fill system are shown relative to changes in the connector devices 44. To this end, FIG. 8 illustrates that the connector devices 44 include inline universal joint members 46 as described in great detail in the first exemplary embodiment above. Another embodiment of the fill system 110 is shown in FIG. 9 and includes many of the same elements labeled with identical reference numbers, such as the agitator plate 30, the storage container 12, and the support legs 16. The fill system 110 of this embodiment includes a different connector device 112 coupling the agitator plate 30 to the support legs 16. The connector device 112 of this embodiment is defined by a cable 114 (which could be a rod, in similar embodiments) extending between and rigidly coupled to two threaded fasteners 116, one of which is engaged with the support leg 16 and the other of which is engaged with the agitator plate 30. Depending on the rigidity and materials of the cables 114 or rods, the agitator plate 30 will be enabled to move and rotate along two or three transverse axes. For example, the cables 114 may be sufficiently rigid so as to limit vertical movement of the agitator plate 30 while allowing for a larger amount of horizontal movement in multiple horizontal directions, in one embodiment. It will be understood that the cables 114 used with the fill system 110 may be modified to suit the specific type of vibratory movement that a user desires to have at the agitator plate 30.

Another embodiment of the fill system 120 is shown in FIG. 10 and includes many of the same elements labeled with identical reference numbers, such as the agitator plate 30, the storage container 12, and the support legs 16. The fill system 120 of this embodiment includes yet another connector device 122, which includes a spring 124 operatively coupled to retention loops 126 located on two threaded fasteners 128. The threaded fasteners 128 are rigidly engaged with the support legs 16 and the agitator plate 30, as with the previous embodiment. Similar to the cable 114 of the previous embodiment, the spring 124 may be formed with different levels of rigidity and different types of materials to enable different amounts of movement of the agitator disc 30 relative to the bottom end 18 of the storage container 12. To this end, the springs 124 of the connector devices 122 may allow for movement of the agitator plate 30 in two or three directions, depending on the amount of vibrations applied at the vibratory motor 66 and the specific needs of the end user. Each of these embodiments of the fill system 10, 110, 120 shown in FIGS. 8 through 10 is capable of providing adhesive solids 82 on demand to the pump inlet chamber 14, as described in detail above.

An additional alternative embodiment of the fill system 140 is shown in FIG. 11. In this embodiment, the fill system 140 includes a modified pump inlet chamber 142 that includes a plurality of additional elements used as pump inlet clearing devices. As with the previously-described embodiment, the pump inlet chamber 142 of FIG. 11 includes a similar upper chamber portion 54 that funnels downwardly to a lower chamber portion 56 communicating with multiple pumps 20. Also similar to the previous embodiment, vacuum generators 62 of the pumps 20 and eductors 64 for blowing compressed air may be used as pump inlet clearing devices to remove all adhesive solids 82 from the lower chamber portion 56 between operational cycles of the pumps 20 (e.g., such as by returning residual adhesive solids 82 back to the storage container 12). The additional elements shown in FIG. 11 may be used as alternatives to one of the vacuum generators 62 and eductors 64 or in addition to these elements, based on the preferences of the end user. At a minimum, however, a vacuum generator or eductor 64 of some sort must be employed because this serves as the primary motive force for the pump 20.

To this end, the fill system 140 includes a cooling device 144 operatively coupled to the pump inlet chamber 142. The cooling device 144 provides refrigeration or cooling energy to any adhesive solids 82 located in the pump inlet chamber 142, especially within the lower chamber portion 56. This cooling energy is configured to prevent coalescing of the adhesive solids 82 into a solidified mass that would block the inlets 58 to the pumps 20.

The fill system 140 may also include multiple types of agitation devices that serve to remove the adhesive solids 82 from the lower chamber portion 56 between operational cycles of the pumps 20. More specifically, the lower chamber portion 56 may include a discharge valve 148 located at the bottom end 60 of the lower chamber portion 56. The discharge valve 148 may selectively open when adhesive solids 82 are left within the lower chamber portion 56 between operational cycles of the pumps 20, thereby removing the adhesive solids 82 from the location where coalescing into solidified masses causes the most concern. The removed adhesive solids 82 may be supplied back to the storage container 12 (such as with a pump) after flowing through the discharge valve 148. Of course, it will be understood that one of the five pumps 20 and its associated eductor 64 already shown in the FIGS. could be dedicated to this function of removing any excess adhesive solids 82 from the lower chamber portion between operational cycles of the other four pumps 20 as described briefly above, in other embodiments.

Therefore, by using one or a plurality of the pump inlet clearing devices, the lower chamber portion 56 and the pump inlet chamber 142 can be assured to not be filled up and blocked by coalesced or solidified adhesive masses between operational cycles of the pumps 20. It will be understood that any combination of these pump inlet clearing devices may be used, even in alternative fill systems including structures different than a vibrating agitator plate 30.

The fill system 140 of FIG. 11 also includes a modified drive for propagating vibration movements in the agitator plate 30. To this end, the agitator plate 30 is not coupled to a vibratory motor 66 and is not supported by the connector devices 44 in this embodiment. Instead, the agitator plate 30 is mounted on a support bracket 154 having a first end 156 attached to the agitator plate 30. The support bracket 154 includes a free second end 158 opposite the first end 156 that may potentially extend outside the pump inlet chamber 142 as shown in FIG. 11. The second end 158 of the support bracket 154 is supported by the framework of the fill system 140, such as by the support legs 16, to maintain the position of the agitator plate 30 relative to the bottom end 18 of the storage container 12. The second end 158 of the support bracket 154 also engages with an air cylinder 160 (schematically shown in FIG. 11) that is configured to repetitively apply quick back-and-forth movements to the support bracket 154. These back-and-forth movements cause rapid rotation of the agitator plate 30 in opposite directions along a generally horizontal plane as well as some vibrations. The rapid switching of rotation directions also adds to the vibrations applied throughout the agitator plate 30 in this embodiment. It will be understood that alternative actuating structures for rotating and vibrating the support bracket 154 and the agitator plate 30 similar to the air cylinder 160 may be used in other similar embodiments of the fill system 140. Furthermore, the arrangement and positioning of the support bracket 154 and the air cylinder 160 can be modified without departing from the scope of the invention. For example, it will be understood that additional frame elements similar to the support bracket 154 (not shown in FIG. 11) and configured to enable free rotation of the agitator plate 30 may be used to support the agitator plate 30 in other embodiments. In another example, the connector devices 44 of the previous embodiments may be used to support the agitator plate 30 as well.

Therefore, each embodiment of the fill system 10, 110, 120, 140 described above provides advantageous benefits of supplying adhesive solids 82 on demand to a plurality of pumps 20 in a pump inlet chamber 14, 142. Thus, problems with stagnation and solidification of adhesive masses adjacent to the pump inlets 58 can be largely avoided, no matter the formulation and shape and size of the adhesive solids 82. Furthermore, the agitation of the bulk supply with vibrations at the agitator plate 30 tends to break apart most solidified masses of adhesive in the storage container 12 as well, thereby enabling the use of these fill systems 10, 110, 120, 140 in what are typically considered non-favorable environments such as hot climates. The various embodiments disclosed herein and reasonable alternative embodiments therefore provide numerous advantages over fill systems of the conventional art.

While the present invention has been illustrated by a description of exemplary embodiments and while these embodiments have been described in some detail, it is not the intention of the Applicants to restrict or in any way limit the scope of the appended claims to such detail. Additional advantages and modifications will readily appear to those skilled in the art. The various features of the invention may be used alone or in any combination depending on the needs and preferences of the user. This has been a description of the present invention, along with the preferred methods of practicing the present invention as currently known. However, the invention itself should only be defined by the appended claims.

What is claimed is:

1. A fill system configured to retain and transfer adhesive solids to an adhesive melter, the fill system comprising:
a storage container for containing a bulk supply of adhesive solids, said storage container including at least one sidewall and a bottom end;
an agitator plate positioned proximate said bottom end of said storage container; and
a vibration generating mechanism operatively coupled to said agitator plate and configured to selectively vibrate said agitator plate to produce a relative motion between said agitator plate and a bottom surface of the bulk supply of adhesive solids, the relative motion agitating the bulk supply to separate adhesive solids from the bulk supply and generate a flow of fluidized adhesive solids, at least a portion of which moves out of said storage container for transfer to the adhesive melter, and wherein the flow of fluidized adhesive solids out of said storage container is stopped when said vibration generating mechanism stops vibrating said agitator plate.

2. The fill system of claim 1, wherein said agitator plate is a circular agitator disc that further comprises:
an outer circumferential edge;
a top surface facing towards said storage container; and
an array of slots provided in said top surface and configured to increase agitation and separation of adhesive solids from the bulk supply when said agitator disc is vibrated.

3. The fill system of claim 2, wherein said agitator disc includes an axial center and each of said slots extends along a radial direction away from said axial center to intersect said outer circumferential edge.

4. The fill system of claim 2, wherein the adhesive solids define an average particle diameter, and each of said slots defines a slot depth that is less than half the average particle diameter of the adhesive solids such that adhesive solids in said slots project upwardly from said top surface and enhance agitation of the bulk supply when said agitator disc is vibrated.

5. The fill system of claim 1, further comprising:
a plurality of support legs coupled to and configured to support said storage container; and
a plurality of connector devices associated with said plurality of support legs, with each of said connector devices operatively coupling said agitator plate to one of said support legs in such a manner that said agitator plate is free to vibrate or move relative to said storage container along and around multiple transverse axes.

6. The fill system of claim 5, wherein said connector devices further comprise universal joint members extending between said support legs and said agitator plate, said universal joint members enabling movement of said agitator plate in all three dimensions relative to said storage container.

7. The fill system of claim 5, wherein said connector devices further comprise cables or rods extending between said support legs and said agitator plate, said cables or rods enabling movement of said agitator plate in at least two dimensions relative to said storage container.

8. The fill system of claim 5, wherein said connector devices further comprise springs extending between said support legs and said agitator plate, said springs enabling movement of said agitator plate in at least two dimensions relative to said storage container.

9. The fill system of claim 1, wherein said vibration generating mechanism includes an electric-actuated vibratory motor operative to move said agitator plate in a vertical direction as well as move and rotate said agitator plate in a horizontal direction.

10. The fill system of claim 9, wherein said agitator plate includes a central plate portion and an outer peripheral edge portion, and said vibratory motor is coupled to said central plate portion of said agitator plate such that vibrations and movement are propagated from said central plate portion to said outer peripheral edge portion to agitate the bulk supply of adhesive solids across an entirety of said agitator plate.

11. The fill system of claim 1, wherein said vibration generating mechanism includes an air cylinder operatively coupled to a support bracket attached to said agitator plate, and said air cylinder rapidly moves said support bracket to vibrate and rapidly rotate said support bracket back and forth.

12. The fill system of claim 1, wherein said agitator plate includes an outer peripheral edge portion that is larger in size than said bottom end of said storage container, and the fill system further comprises:
a pump inlet chamber including a chamber sidewall that at least circumferentially surrounds said outer peripheral edge portion of said agitator plate, such that a gap is formed between said agitator plate and said bottom end of said storage container, said gap configured to receive the flow of fluidized adhesive solids that has been separated from the bulk supply by vibration of said agitator plate and then transfer the flow of fluidized adhesive solids to said pump inlet chamber; and
at least one pump communicating with said pump inlet chamber and configured to remove the flow of fluidized adhesive solids from said pump inlet chamber and deliver the flow of fluidized adhesive solids to the adhesive melter.

13. The fill system of claim 12, wherein said outer peripheral edge portion and said gap define a gap angle through which the flow of fluidized adhesive solids must move to exit said storage container, the gap angle being less than an angle of repose defined by the adhesive solids so that the flow of fluidized adhesive solids from said storage container is stopped when said agitator plate stops vibrating.

14. The fill system of claim 12, further comprising:
a pump inlet clearing device associated with said pump inlet chamber and configured to keep said pump inlet chamber clear of solidified masses formed by the flow of fluidized adhesive solids between operational cycles of said at least one pump.

15. The fill system of claim 1, wherein said storage container includes a top opening, said at least one sidewall extends between said top opening and said bottom end, and said at least one sidewall is formed from or coated with a friction reducing material facing towards the bulk supply of adhesive solids.

16. The fill system of claim 15, wherein said at least one sidewall is angled slightly outwardly such that said top opening is smaller than said bottom end of said storage container.

17. A method of transferring adhesive solids to an adhesive melter with a fill system including a storage container including a bottom end and an agitator plate located proximate to the bottom end, the method comprising:
storing a bulk supply of adhesive solids within the storage container;
engaging the agitator plate with a bottom surface of the bulk supply of adhesive solids;
vibrating the agitator plate to produce relative motion between the agitator plate and the bottom surface of the bulk supply, the relative motion separating adhesive solids from the bulk supply to generate a flow of fluidized adhesive solids, at least a portion of which moves out of the storage container for transfer to the adhesive melter; and
stopping the flow of fluidized adhesive solids from moving out of the storage container when the agitator plate stops vibrating.

18. The method of claim 17, wherein the agitator plate includes an outer circumferential edge, and vibrating the agitator plate further comprises:
actuating an electric vibratory motor coupled to the agitator plate to generate vibration movement of the agitator plate along a vertical direction as well as movement and rotation along a horizontal direction; and
agitating the bulk supply of adhesive solids with the vibration movement to separate adhesive solids from the bulk supply and thereby generate the flow of fluidized adhesive solids.

19. The method of claim 18, wherein the electric vibratory motor is coupled to a central plate portion of the agitator plate, and vibrating the agitator plate further comprises:
transmitting vibrations throughout the agitator plate from the central plate portion such that the bulk supply of adhesive solids is agitated evenly across the agitator plate.

20. The method of claim 17, wherein the agitator plate includes a top surface facing towards the storage container and an array of slots formed in the top surface, and vibrating the agitator plate further comprises:
generating a flow of fluidized adhesive solids to sit at least partially in the array of slots; and
transmitting vibrations from the agitator plate through the adhesive solids sitting at least partially in the array of slots to enhance agitation of the bulk supply of adhesive solids.

21. The method of claim 17, wherein the agitator plate includes a support bracket operatively engaged with an air cylinder, and vibrating the agitator plate further comprises:
actuating the air cylinder repeatedly to generate vibration and rapid rotation of the agitator plate back and forth in opposing directions; and
agitating the bulk supply of adhesive solids with the vibration and rapid rotation to break adhesive solids from the bulk supply and thereby generate the flow of fluidized adhesive solids.

22. The method of claim 17, wherein the fill system also includes a pump inlet chamber communicating with the storage container and at least one pump communicating with the pump inlet chamber, and the method further comprises:
supplying the flow of fluidized adhesive solids that moves out of the storage container into the pump inlet chamber; and
removing the flow of fluidized adhesive solids in the pump inlet chamber with the at least one pump to deliver the adhesive solids to the adhesive melter.

23. The method of claim 22, further comprising:
removing adhesive solids from the pump inlet chamber with at least one pump inlet clearing device between fill cycles from the storage container, wherein the removed adhesive solids are delivered to the adhesive melter or back to the storage container by the at least one pump inlet clearing device.

24. The method of claim 17, wherein the agitator plate includes an outer peripheral edge portion that is larger than the bottom end of the storage container, and the method further comprises:
forcing the flow of fluidized adhesive solids to move horizontally along the agitator plate before the flow of fluidized adhesive solids moves around the agitator plate and out of the storage container.
